(19) United States
(12) Patent Application Publication
(10) Pub. No.: US 2004/0128531 A1
(43) Pub. Date: Jul. 1, 2004

(54) Security network and infrastructure

(76) Inventor: Ben Aaron Rotholtz, Yarrow Point, WA (US)

Correspondence Address: DENIS G. MALONEY, Fish & Richardson P.C., 225 Franklin Street, Boston, MA, 02110-2804, US

(21) Appl. No.: 10/335,551

(22) Filed: Dec. 31, 2002

(51) Int. Cl. H04L 9/00

(52) U.S. Cl. 713/200

(57) ABSTRACT

A security network includes a distributed computing network that has redundant data paths. A plurality of addressable security feed transmitting devices each transmit a data feed over one or more of the redundant data paths. The data feed is representative of the area being monitored by the security feed transmitting device. One or more security feed receiving devices access the data feed from each addressable security feed transmitting device.

### TECHNICAL FIELD

This description relates to security networks.

### BACKGROUND

Security networks use an infrastructure to connect one or more security cameras to a centralized monitoring station. These cameras are typically video cameras (transmitting signals using the National Television Standards Committee “NTSC” or Phase Alternation Line “PAL” signal formats), each of which uses a coaxial cable to transmits it video feed to a centralized monitoring station. These centralized monitoring stations typically includes a switching device that allows security personnel to switch between video feeds and select the camera that they wish to monitor.

As these security networks are stand-alone systems, the video feeds from cameras on a first security network are not viewable on monitoring stations for a second security network.

### SUMMARY

According to an aspect of this invention, a security network includes a distributed computing network that has redundant data paths. A plurality of addressable security feed transmitting devices each transmit a data feed over one or more of the redundant data paths. The data feed is representative of the area being monitored by the security feed transmitting device. One or more security feed receiving devices access the data feed from each addressable security feed transmitting device.

One or more advantages can be provided. A modular security system can be produced. By deploying a security system on a broad-based network, existing infrastructure may be used. Further, as the network does not require a dedicated wire run for each added device, system expansion is simplified. Additionally, as the access to individual devices can be controlled, a single network may function as the backbone for multiple security systems. Accordingly, this removes hardware-based access limitations, as any user that has access to the distributed computing network may access any device attached to the network, provided they have the requisite access rights.

Other features will be apparent from the following description, including the drawings, and the claims.

### DESCRIPTION OF DRAWINGS

FIG. 1 is a diagrammatic view of a security network;

FIG. 2 is a more detailed view of a portion of the security network of FIG. 1;

FIG. 3 is a more detailed view of a portion of the security network of FIG. 1; and

FIG. 4 is a block diagram of a security networking method.

### DETAILED DESCRIPTION

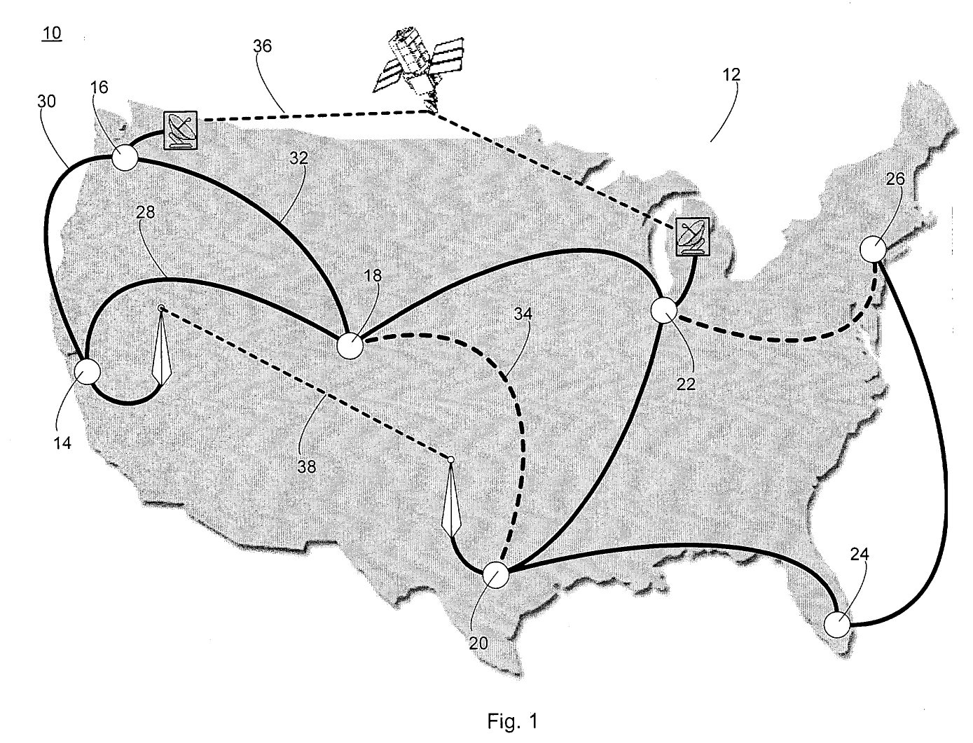

Referring to FIG. 1, a security network 10 includes a distributed computing network 12 (e.g., the Internet, a corporate intranet, an Ethernet network, etc.) that functions as the backbone of security network 10. The devices (e.g., devices 14, 16, 18, 20, 22, 24, 26) connected to distributed computing network 12 are interconnected using redundant data paths, such as data path 28 and the combination of data paths 30, 32, thus allowing continued communication between device 14 and device 18 in the event that either of these data paths fail. These redundant data paths may be constructed of standard copper conductors (e.g., data paths 28, 30, 32), or any other type of conductor-based (e.g., fiber-optic data path 34) or wireless signal transmission topology (e.g., satellite link 36, modulated transmission link 38). The devices (e.g., devices 14, 16, 18, 20, 22, 24, 26) connected to the distributed computing network 12 are addressable devices, thus allowing for targeted communication between devices. As distributed computing network 12 is typically a TCP/IP (i.e., Transmission Control Protocol/Internet Protocol) network, devices 14, 16, 18, 20, 22, 24, 26 are typically IP (i.e., Internet Protocol) addressable devices. TCP/IP is the basic communication language or protocol of the Internet. This addressing will be discussed below in greater detail. During operation of security network 10, the devices attached to the distributed computing network 12 to transmit data to each other.

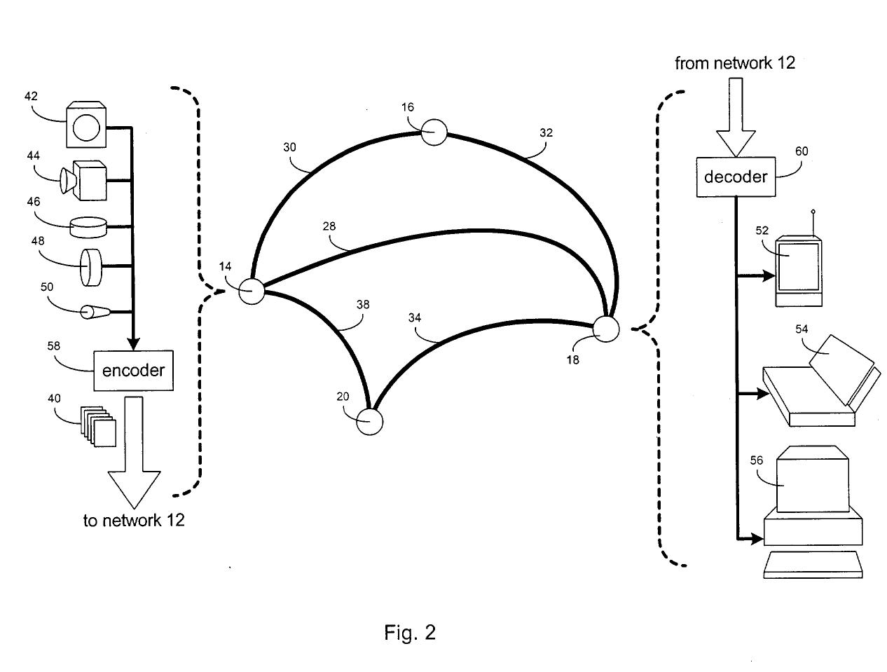

Referring also to FIG. 2, these devices can be categorized as addressable security feed transmitting devices (e.g., device 14) and security feed receiving devices (e.g., device 18). The security feed transmitting devices transmits a data feed 40 across distributed computing network 12, such that the data feed 40 is accessible by the security feed receiving devices. Accordingly, if security network 10 included multiple security, feed transmitting devices, each of these devices would generate at least one data feed (to be discussed below in greater detail). Each of these generated data feeds would be accessible by each security feed receiving device incorporated into security network 10, provided the user who is using the security feed receiving device to gain access to the data feed has the requisite access level (to be discussed below in greater detail).

Examples of security feed transmitting device 14 include radiation detectors 42, video cameras 44, motion detectors 46, thermal imaging detectors 48 and audio detectors 50. Additionally, these device maybe combined to form hybrid devices, such as a combination video camera/audio detector. Therefore, this hybrid device would actually generate either two data feeds (one for video and one for audio) or a single data feed that includes both video and audio components.

Examples of security feed receiving device 18 include various computing devices, such as PDA's (i.e., Personal Digital Assistants) 52, portable computers 54, and desktop computers. 56.

The security feed transmitting devices (e.g., device 14) may be hardwired or wirelessly connected to the distributed computing network 12. For example, a video surveillance camera (e.g., camera) 14 that is located indoors and is positioned proximate a power supply and a network connection may be hardwired to network 12. However, a video camera that is positioned proximate the perimeter to a nuclear power plant may be near a network connection or a power supply. Accordingly, this video camera, which may be powered by a battery that is recharged by a solar cell, may transmit its data feed wirelessly to a network access point. An example of this wireless transmission methodology is the 802.11, 802.11(a), 802.11(b), and 802.11(g) protocol defined by the IEEE (i.e., Institute of Electrical and Electronics Engineers). When this protocol is employed a wireless access point (not shown) is connected to the distributed computing network 12 and a bidirectional communication channel is established between the device (e.g., the remotely-located video camera) and the wireless access point.

The security feed receiving devices (e.g. device 18) may also be hardwired or wirelessly connected to the distributed computing network 12. For example, a portable computer in a police car may be wirelessly connected to the distributed computing network 12 through a data link established between the police car and the police station (which is hardwired to the distributed computing network 12. Accordingly, a police officer can access and monitor the video-based data feed generated by the remotely-located video camera (described above) from the safety and comfort of their patrol car. Therefore, in the event of a terrorist situation occurring at the above described nuclear power plant, the police office can ascertain the situation inside of the power plant without having to blindly enter the building itself. Further, the office need not be confined to his car to monitor the situation inside of a building. For example, through the use of a wireless, PDA, the police officer can access network 12 and, therefore, the data feed generated by the camera in question. Alternatively, the combination of a Bluetooth-compatible data-enabled cellular phone and a Bluetooth-compatible PDA, a communication link between the PDA and network 12 can be established via the Bluetooth-compatible cellular phone.

As described above, devices 14, 16, 18, 20, 22, 24, 26 are typically IP addressable devices. The IP addresses assigned to these devices can occur either statically or dynamically. For static address assignment, a static IP addressed is typically assigned to the device using a firmware/BIOS (i.e., basic input/output system) configuration utility (not shown). Through the use of this utility, the various communication parameters of the device are configured, such as the IP address (i.e., the address of the device), the subnet mask (i.e., the sub-network within a larger network), and the default gateway (i.e., a network point that acts as the entrance to another network). As these parameters become difficult manage and the size of the network and the number of devices increase, a DHCP (i.e., Dynamic Host Configuration Protocol) server (e.g., device 16) may be incorporated into network 12 so that the above-described communication parameter can be automatically assigned and managed. During operation, when a device (e.g., device 14) is attached to network 12 and powered-up, the DCHP server attached to the network is contacted by the newly-attached device and the DHCP server assigns to the device an IP address chosen from a pool of available IP addresses and specifies the default gateway and subnet mask for the device.

As distributed computing network 12 may be a non-private network (e.g., the Internet), the various data feeds generated by the devices attached to the network may be encrypted to prevent unregulated monitoring, modification, or disruption of these feeds. Accordingly, an encoder 58 may be incorporated into the transmitting device (e.g., device 14) or positioned between the device and network 12 so that data feed 40 is encrypted prior to it being transmitted across network 12. If such an encoder is used, a decoder 60 would be used to decrypt the now-encrypted data feed when it is received by the receiving device (e.g., device 18). As with the encoder 58, decoder 60 may be incorporated into the receiving device or used to interconnect the receiving device and network 12.

Encoder 58 and decoder 60 use various ciphers (i.e., methods of encrypting data) range in complexity from simple (e.g., the substitution of letters for numbers, the rotation of letters in the alphabet, and the “scrambling” of voice signals by inverting the sideband frequencies) to complex (e.g., sophisticated computer algorithms that rearrange the data bits in digital signals).

Since distributed computing network 12 is a non-private network that may spot multiple sub-networks, each of which is a stand-alone security system, if is desirable to control the access that the users on the system have to the various devices attached to network 12. Accordingly, an administration server (e.g., device 20) may be attached to the distributed computing network 12 (or an sub-network thereof), so that the access rights of the users of the security network can be defined.

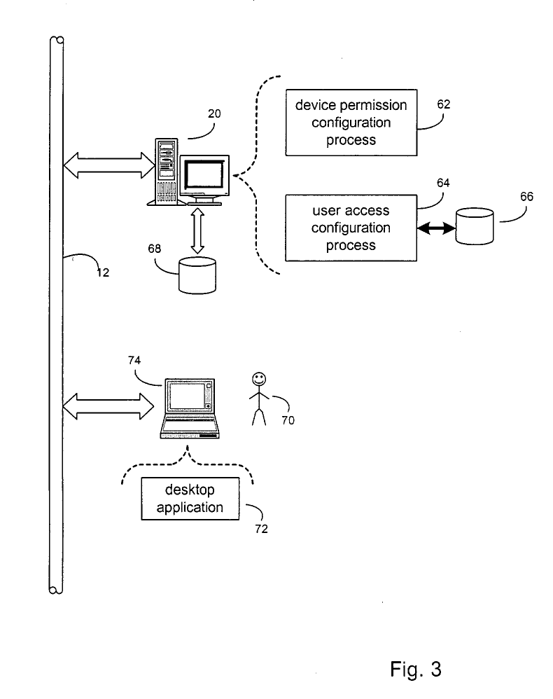

Referring now to FIG. 3, a device permission configuration process 62, a user access configuration process 64, and a database 66 reside on and are executed by administration server 20. The instruction sets and subroutines of processes 62, 64 and database 66 are typically stored on a storage device 68 connected to computer 20. Storage device 68 may be, for example, a hard disk drive, a tape drive, an optical drive, a RAID array, a random access memory (RAM), or a read-only memory (ROM).

Administrator 70 typically accesses and uses processes 62, 64 and database 66 through a desktop application 72 (e.g., Microsoft Internet Explorer™, Netscape Navigator™, or a specialized desktop interface) running on a computer 74 that is also connected to the network 12.

Device permission configuration process 62 allows administrator to assign a requisite access level to the transmitting devices (e.g., devices 42, 44, 46, 48, 50). Additionally, user access configuration process 64 allows the administrator 70 to assign a user access level to each of the users of the security network 10, which are stored on database 66. Examples of database 66 are Oracle™, Access™, and SQL™databases.

Accordingly, when a user log into security network 10, the access level of that particular user are retrieved from database 66. When the user subsequently attempts to access a data feed generated by a transmitting device, the requisite access level of that device is determined. This requisite access level may be stored on the device itself (e.g., in non-volatile memory) or on database 66. If the user's access level is not an equivalent to or greater than the requisite access level of the device the user is attempting to access, the user is denied access to that device. Through user access configuration process 64, user can be assigned to group, such that all members of the group have equivalent access rights. Therefore, entry-level employees may be given low-level access, while management may be given higher-level access.

While the DHCP server and administration server are described above as being separate servers, the functions performed by these two servers may be implemented on a single server.

While the device connected to distributed computing network 12 are described above as being directly connected to the network, other configurations are possible. For example, video camera 44 may be a USB (i.e., Universal Serial Bus) camera that is connect to a computer, such that the computer is connected to network 12. Additionally, a router or gateway (not shown) may be used to connect a sub-network (e.g., an intranet) to a larger network (e.g., the Internet). This router/gateway may include a DHCP server so that the devices (e.g., devices 14, 16, 18, 20, 22, 24, 26) are assigned a dynamic IP address by the DHCP server incorporated into the router/gateway. Alternatively, a server executing a proxy server/DHCP application may be configured to perform the function of a router/gateway by bridging or linking the sub-network (e.g., the intranet) to the larger network (i.e., the Internet).

While the distributed computing network is described above as a TCP/IP addressable network, other configurations are possible, such as NetBEUI (i.e., NetBIOS Extended User Interface), which allows computers to communicate within a local area network, such as an Ethernet network).

While the device used in the above-described system are described as being either addressable security feed transmitting devices or and security feed receiving devices, other configurations are possible, such as a device that generates a first data feed while monitoring a second data feed. Accordingly, bidirectional devices may be incorporated into system 10.

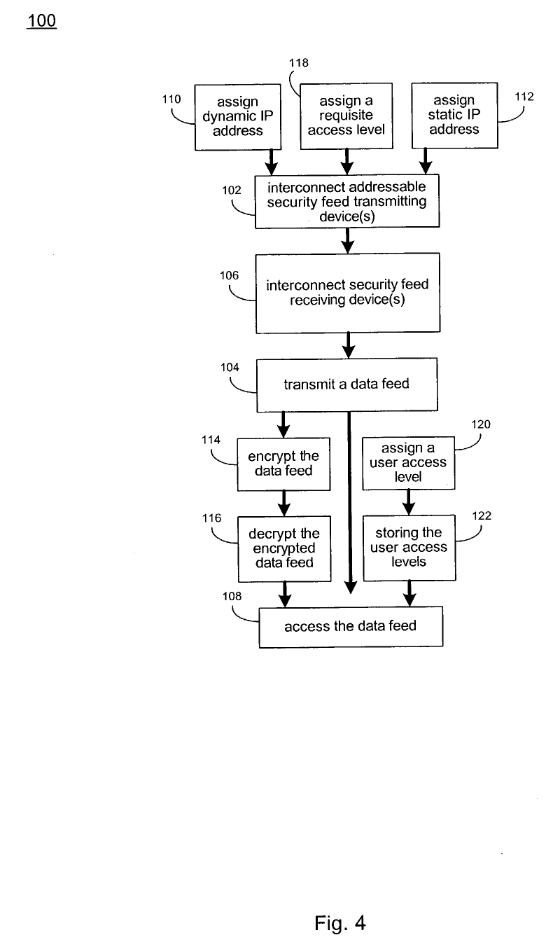

Referring to FIG. 4, a security networking process 100 includes interconnecting at least one addressable security feed transmitting device to a distributed computing network having redundant data paths 102. A data feed is transmitted over one or more of the redundant data paths 104). This data feed is representative of the area being monitored by the security feed transmitting device. One or more security feed receiving devices are interconnected to the distributed computing network 106. The data feed from the addressable security feed transmitting device is accessible with the one or more security feed receiving devices 108.

A dynamic IP address or a static IP address may be assigned to at least one addressable security feed transmitting device 110, 112. The data feed generated by the at least one addressable security feed transmitting device is encrypted prior to being transmitted on the distributed computing network 114. such that the encrypted data feed is decrypted once retrieved from the network 116.

A requisite access level is assigned to the at least one addressable security feed transmitting devices 118 and a user access level is assigned to one or more users of the security method 120. A user can only access the at least one addressable security feed transmitting device if the user access level of the user is at least equivalent to the requisite access level of the at least one addressable security feed transmitting device. The user access levels assigned to the one or more users of the security method are stored on a database 122.

The system described herein is not limited to the implementation described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor including volatile and non-volatile memory and/or storage elements. Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the system. The system may also be implemented as a machine-readable storage medium, configured with a computer program, where, upon execution, instructions in the computer program cause a machine to operate to perform the functions of the system described above.

Implementations of the system may be used in a variety of applications. Although the system is not limited in this respect, the system may be implemented with memory devices in microcontrollers, general purpose microprocessors, digital signal processors DSPs, reduced instruction-set computing RISC, and complex instruction-set computing CISC, among other electronic components.

Implementations of the system may also use integrated circuit blocks referred to as main memory, cache memory, or other types of memory that store electronic instructions to be executed by a microprocessor or store data that may be used in arithmetic operations.

A number of implementations have been described. Nevertheless, it will be understood that various modifications may be made. Accordingly, other implementations are within the scope of the following claims.

What is claimed is:

1. A security network comprising:
a distributed computing network having redundant data paths;
a plurality of addressable security feed transmitting devices, each of which transmits a data feed over one or more of the redundant data paths, the data feed being representative of the area being monitored by the security feed transmitting device; and
one or more security feed receiving devices, the data feed from each addressable security feed transmitting device being accessible by the one or more security feed receiving devices.

2. The security network of claim 1 wherein the distributed computing network is a TCP/IP network.

3. The security network of claim 2 wherein at least one of the addressable security feed transmitting devices is addressable using an IP address.

4. The security network of claim 3 wherein at least one of the addressable security feed transmitting devices is a video camera.

5. The security network of claim 3 wherein at least one of the addressable security feed transmitting devices is a radiation detector.

6. The security network of claim 3 wherein at least one of the addressable security feed transmitting devices is a motion detector.

7. The security network of claim 3 wherein at least one of the addressable security feed transmitting devices is a thermal imaging device.

8. The security network of claim 3 wherein at least one of the addressable security feed transmitting devices is an audio detector.

9. The security network of claim 3 wherein the IP address is a static IP address.

10. The security network of claim 3 wherein the IP address is a dynamic IP address.

11. The security network of claim 10 further comprising a DHCP server that is interconnected with the distributed computing network and assigns the dynamic IP address to the at least one addressable security feed transmitting device.

12. The security network of claim 1 wherein at least one of the security feed receiving devices is a computing device.

13. The security network of claim 1 wherein at least one of the addressable security feed transmitting devices is hardwired to the distributed computing network.

14. The security network of claim 1 wherein at least one of the addressable security feed transmitting devices is wirelessly connected to the distributed computing network.

15. The security network of claim 1 further comprising an encoder for interconnecting at least one of the addressable security feed transmitting devices to the distributed computing network, wherein the encoder encrypts the data feed generated by the at least one addressable security feed transmitting device.

16. The security network of claim 15 further comprising a decoder for interconnecting at least one of the security feed receiving devices to the distributed computing network, wherein the decoder decrypts the encrypted data feed generated by the encoder.

17. The security network of claim 1 further comprising a device permission configuration process, executed on an administration server that is interconnected with the distributed computing network, for assigning a requisite access level to at least one of the addressable security feed transmitting devices.

18. The security network of claim 17 further comprising a user access configuration process, executed on the administration server, for assigning a user access level to one or more users of the security network, wherein a user can only access the at least one addressable security feed transmitting device if the user access level of the user is at least equivalent to the requisite access level of the at least one addressable security feed transmitting device.

19. The security network of claim 18 further comprising a database, executed on the administration server, for storing the user access levels assigned to the one or more users of the security network.

20. A security network comprising:
a TCP/IP-based distributed computing network;
at least one addressable security feed transmitting device for transmitting a data feed over the distributed computing network, the data feed being representative of the area being monitored by the security feed transmitting device; and
at least one encoder for interconnecting the at least one addressable security feed transmitting device to the distributed computing network, and encrypting the data feed generated by the at least one addressable security feed transmitting device;
at least one security feed receiving device;
at least one decoder for interconnecting the at least one security feed receiving device to the distributed computing network, and decrypting the encrypted data feed generated by the encoder, the data feed from the at least one addressable security feed transmitting device being accessible by the at least one security feed receiving device.

21. The security network of claim 20 wherein at least one of the addressable security feed transmitting devices is addressable using an IP address.

22. The security network of claim 21 wherein at least one of the addressable security feed transmitting devices is a video camera.

23. The security network of claim 21 wherein at least one of the addressable security feed transmitting devices is a radiation detector.

24. The security network of claim 21 wherein at least one of the addressable security feed transmitting devices is a motion detector.

25. The security network of claim 21 wherein at least one of the addressable security feed transmitting devices is a thermal imaging device.

26. The security network of claim 21 wherein at least one of the addressable security feed transmitting devices is an audio detector.

27. A security network comprising:
a TCP/IP-based distributed computing network;
at least one addressable security feed transmitting device for transmitting a data feed over the distributed computing network, the data feed being representative of the area being monitored by the security feed transmitting device;
a DHCP server, interconnected with the distributed computing network, for assigning a dynamic IP address to the at least one addressable security feed transmitting device; and
at least one security feed receiving device, the data feed from the at least one addressable security feed transmitting device being accessible by the at least one security feed receiving device.

28. The security network of claim 27 wherein at least one of the security feed receiving devices is a computing device.

29. The security network of claim 27 wherein at least one of the security feed receiving devices is hardwired to the distributed computing network.

30. The security network of claim 27 wherein at least one of the security feed receiving devices is wirelessly connected to the distributed computing network.

31. A security network comprising:
a distributed computing network having redundant data paths;
a plurality of addressable security feed transmitting devices, each of which transmits a data feed over one or more of the redundant data paths, the data feed being representative of the area being monitored by the security feed transmitting device; and
one or more security feed receiving devices, the data feed from each addressable security feed transmitting device being accessible by the one or more security feed receiving devices.

32. The security network of claim 31 further comprising a device permission configuration process, executed on an administration server that is interconnected with the distributed computing network, for assigning a requisite access level to at least one of the addressable security feed transmitting devices.

33. The security network of claim 32 further comprising a user access configuration process, executed on the administration server, for assigning a user access level to one or more users of the security network, wherein a user can only access the at least one addressable security feed transmitting device if the user access level of the user is at least equivalent to the requisite access level of the at least one addressable security feed transmitting device.

34. The security network of claim 33 further comprising a database, executed on the administration server, for storing the user access levels assigned to the one or more users of the security network.

35. A method of operating a security network, the method comprising:
transmitting a data feed over one or more of redundant data paths of a distributed computing network, the data feed being representative of the area being monitored by the security feed transmitting device, the network having at least one addressable security feed transmitting device and one or more security feed receiving devices coupled to the distributed computing network; and
accessing the data feed from the addressable security feed transmitting device with the one or more security feed receiving devices.

36. The security networking method of claim 35 wherein the distributed computing network is a TCP/IP network.

37. The security networking method of claim 36 further comprising assigning a dynamic IP address to the at least one addressable security feed transmitting device.

38. The security networking method of claim 36 further comprising assigning a static IP address to the at least one addressable security feed transmitting device.

39. The security networking method of claim 35 further comprising encrypting the data feed generated by the at least one addressable security feed transmitting device.

40. The security networking method of claim 39 further comprising decrypting the encrypted data feed.

41. The security networking method of claim 35 further comprising assigning a requisite access level to the at least one addressable security feed transmitting devices.

42. The security networking method of claim 41 further comprising assigning a user access level to one or more users of the security method, wherein a user can only access the at least one addressable security feed transmitting device if the user access level of the user is at least equivalent to the requisite access level of the at least one addressable security feed transmitting device.

43. The security networking method of claim 42 further comprising storing the user access levels assigned to the one or more users of the security method.
